(19) United States
(12) Patent Application Publication
(10) Pub. No.: US 2026/0089739 A1
(43) Pub. Date: Mar. 26, 2026

(54) METHOD AND DEVICE FOR SENDING OR MONITORING DOWNLINK CONTROL INFORMATION, DEVICE AND MEDIUM

(71) Applicant: Beijing Xiaomi Mobile Software Co., Ltd., Beijing (CN)

(72) Inventor: Ting FU, Beijing (CN)

(21) Appl. No.: 19/113,373

(22) PCT Filed: Sep. 22, 2022
(86) PCT No.: PCT/CN2022/120665

§ 371 Date: Mar. 19, 2025

(51) Int. Cl. H04W 72/232; H04W 72/1263

(52) U.S. Cl. CPC H04W 72/232; H04W 72/1263

(57) ABSTRACT

A method for monitoring downlink control information (DCI), including: monitoring in a case where a synchronization signal/PBCH block (SSB) corresponds to a plurality of monitoring occasions in each system information (SI) window, on partial monitoring occasions of the plurality of monitoring occasions corresponding to the SSB in the SI window, DCI configured for scheduling SI.

### CROSS-REFERENCE TO RELATED APPLICATION

The present application is a U.S. National Stage of International Application No. PCT/CN2022/120665, filed on Sep. 22, 2022, the contents of all of which are incorporated herein by reference in their entirety for all purposes.

### BACKGROUND OF THE INVENTION

In a New Radio (NR) system, a system information block 1 (SIB1) includes scheduling information. Each piece of the scheduling information indicates one or more scheduled system information (SI). The scheduling information includes window length. The window length indicates a SI window length for the scheduled SI. Each SI has a corresponding SI window. The SI window length is generally in units of slots. The SI window length for all scheduled SI may be the same.

In a specific search space within the SI window, a network device schedules the SI corresponding to the SI window through downlink control information (DCI). The SI windows corresponding to different SIs do not overlap at all in time domain, i.e., only one SI can be scheduled in one SI window, and a plurality of SI cannot be scheduled in a single SI window.

A specific search space within an SI window is a search space for transmission of the DCI. Each SI window contains a plurality of monitoring occasions (MOs). The MO is configured to monitor a Physical Downlink Control Channel (PDCCH). The DCI is carried on the PDCCH.

The plurality of MOs in the SI window have a pre-set correspondence with a synchronization signal/PBCH block (SSB) transmitted by a network device. According to the correspondence, in one SI window, one SSB may correspond to a plurality of PDCCH MOs.

### SUMMARY OF THE INVENTION

The present disclosure relates to the technical field of wireless communications, and in particularly, to a method and device for transmitting or monitoring downlink control information, a device, and a medium.

In a first aspect, a method for monitoring downlink control information (DCI) is provided, which is performed by a user equipment and includes:
monitoring in a case where a synchronization signal/PBCH block (SSB) corresponds to a plurality of monitoring occasions in each system information (SI) window, on partial monitoring occasions of the plurality of monitoring occasions corresponding to the SSB in the SI window, DCI configured for scheduling SI.

In a second aspect, a method for transmitting downlink control information (DCI) is provided, which is performed by a network device and includes:
transmitting in a case where a synchronization signal/PBCH block (SSB) corresponds to a plurality of monitoring occasions in each system information (SI) window, on partial monitoring occasions of the plurality of monitoring occasions corresponding to the SSB in the SI window, DCI configured for scheduling SI.

In a third aspect, a device for monitoring downlink control information (DCI) is provided, which is configured in a user equipment, and includes:
a transceiving module, configured to monitor in a case where a synchronization signal/PBCH block (SSB) corresponds to a plurality of monitoring occasions in each system information (SI) window, on partial monitoring occasions of the plurality of monitoring occasions corresponding to the SSB in the SI window, DCI configured for scheduling SI.

In a fourth aspect, a device for transmitting downlink control information (DCI) is provided, which is configured in a network device, and includes:
a transceiving module, configured to transmit in a case where a synchronization signal/PBCH block (SSB) corresponds to a plurality of monitoring occasions in each system information (SI) window, on partial monitoring occasions of the plurality of monitoring occasions corresponding to the SSB in the SI window, DCI configured for scheduling SI.

In a fifth aspect, an electronic device including one or more processors and a memory is provided, where,
the memory is configured to store a computer program; and
the one or more processors are collectively configured to perform the computer program to implement the first aspect or any one of the designs of the first aspect.

In a sixth aspect, an electronic device including one or more processors and a memory is provided, where,
the memory is configured to store a computer program; and
the one or more processors are collectively configured to perform the computer program to implement the second aspect or any one of the designs of the second aspect.

In a seventh aspect, a non-transitory computer readable storage medium is provided, the non-transitory computer readable storage medium storing instructions, where the instructions, when executed on a computer, cause the computer to perform the first aspect or any one of the designs of the first aspect.

In an eighth aspect, a non-transitory computer readable storage medium is provided, the non-transitory computer readable storage medium storing instructions, where the instructions, when executed on a computer, cause the computer to perform the second aspect or any one of the designs of the second aspect.

### BRIEF DESCRIPTION OF DRAWINGS

The accompanying drawings described in the present disclosure are used to provide a further understanding of the embodiments of the present disclosure and constitute a part of the present application, and examples of the embodiments of the present disclosure and descriptions of the embodiments are used to explain the embodiments of the present disclosure, and do not constitute an undue limitation of the embodiments of the present disclosure.

The accompanying drawings, which are incorporated in and constitute a part of this specification, illustrate embodiments consistent with embodiments of the present disclosure and together with the specification, serve to explain the principles of embodiments of the present disclosure.

FIG. 1 is an architecture schematic diagram of a wireless communication system according to an embodiment of the present disclosure.

FIG. 2 is a schematic diagram of a method for transmitting and monitoring downlink control information according to an embodiment of the present disclosure.

FIG. 3 is a schematic diagram of a method for transmitting and monitoring downlink control information according to an embodiment of the present disclosure.

FIG. 4 is a schematic diagram of a method for transmitting and monitoring downlink control information according to an embodiment of the present disclosure.

FIG. 5 is a flowchart of a method for monitoring downlink control information according to an embodiment of the present disclosure.

FIG. 6 is a flowchart of a method for transmitting downlink control information according to an embodiment of the present disclosure.

FIG. 7 is a structure diagram of a user equipment according to an embodiment of the present disclosure.

FIG. 8 is a structure diagram of another user equipment according to an embodiment of the present disclosure.

FIG. 9 is a structural diagram of a network device according to an embodiment of the present disclosure.

FIG. 10 is a structure diagram of another network device according to an embodiment of the present disclosure.

### DETAILED DESCRIPTION OF THE INVENTION

Embodiments of the present disclosure will now be further described with reference to the accompanying drawings and detailed embodiments.

Examples which are shown in the accompanying drawings will be described in detail. When the following description refers to the drawings, the same numerals in different drawings denote the same or similar elements unless otherwise indicated. The embodiments described in the following examples do not represent all embodiments consistent with the embodiments of the present disclosure. Rather, they are merely examples of devices and methods consistent with some aspects of the present disclosure as detailed in the appended claims.

The terminology used in the embodiments of the present disclosure is for the purpose of describing particular embodiments only and is not intended to limit the embodiments of the present disclosure. As used in embodiments of the present disclosure and the appended claims, the singular forms “a”, “an”, and “the” are intended to include the plural forms as well, unless the context clearly indicates otherwise. It will also be understood that the term “and/or” as used in the present disclosure refers to and encompasses any and all possible combinations of one or more of the associated listed items.

It is to be understood that although the terms first, second, third, etc. may be employed in the embodiments of the present disclosure to describe various pieces of information, such pieces of information should not be limited to these terms. These terms are only used to distinguish the same type of information from one another. For example, first information may also be referred to as second information, and, similarly, second information may also be referred to as first information, without departing from the scope of the embodiments of the present disclosure. The word “if” as used in the present disclosure may be interpreted to mean “upon” or “when” or “in response to determining”, depending on the context.

Embodiments of the present disclosure are described in detail below, examples of which are illustrated in the accompanying drawings, in which the same or similar reference numerals denote the same or similar elements throughout. The embodiments described below with reference to the accompanying drawings are exemplary and are intended to be used to explain the present disclosure, and are not to be construed as limiting the present disclosure.

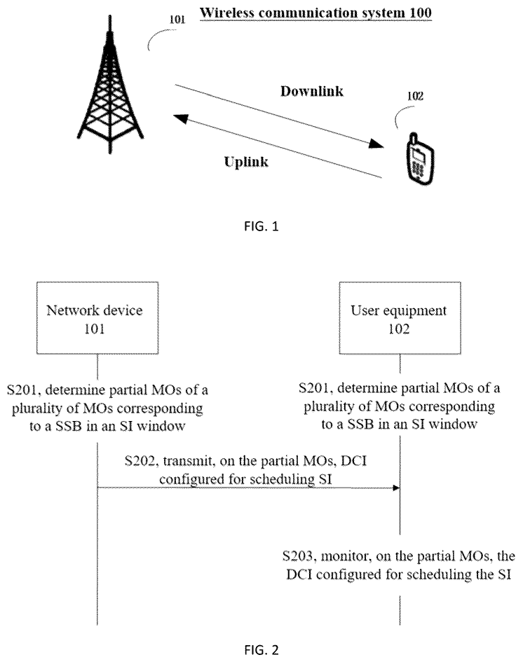

As shown in FIG. 1, a method for monitoring downlink control information provided by an embodiment of the present disclosure may be applied to a wireless communication system 100. The wireless communication system 100 may include, but is not limited to, a network device 101 and a user equipment 102. The user equipment 102 is configured to support carrier aggregation. The user equipment 102 can be connected with a plurality of carrier units of the network device 101. The plurality of carrier units include one primary carrier unit and one or more secondary carrier units.

It is to be understood that the wireless communication system 100 is applicable to both low frequency and high frequency scenarios. Application scenarios of the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-Generation (5G) system, a new radio (NR) communication system, a future evolved public land mobile network (PLMN) system, or the like.

The user equipment 102 may be a user equipment (UE), a terminal, an access terminal, a terminal unit, a terminal station, a mobile station (MS), a remote station, a remote terminal, a mobile terminal, a wireless communication device, an end agent, a user equipment, or the like. The user equipment 102 may have a wireless transceiving function, and may be capable of communicating (e.g., wirelessly) with one or more network devices 101 of one or more communication systems, and receiving network services provided by the network devices 101. The network devices 101 include but are not limited to the illustrated base stations.

The user equipment 102 may be a cellular phone, a cordless phone, a session initiation protocol (SIP) phone, a wireless local loop (WLL) station, a personal digital assistant (PDA) device, a handheld device with wireless communication capability, a computing device or other processing device connected to a wireless modem, a vehicle mounted device, a wearable device, a user equipment in a future 5G network or a user equipment in a future evolved PLMN network, etc.

The network device 101 may be an access network device (or access network site). An access network device refers to a device that provides network access functions, such as a radio access network (RAN) base station or the like. The network device may include a base station (BS) device, or include a base station device and a radio resource management device for controlling the base station device, or the like. The network device may also include a relay station (relay device), an access point, a base station in a future 5G network, a base station in a future evolved PLMN network, an NR base station, or the like. The network device may be a wearable device or a vehicle mounted device. The network device may also be a communication chip with a communication module.

For example, the network device 101 includes, but is not limited to, a next-generation Node B (gnodeB, gNB) in 5G, an evolved node B (eNB) in a LTE system, a radio network controller (RNC), a node B (NB) in a WCDMA system, a radio controller under a CRAN system, a base station controller (BSC), a base transceiver station (BTS) in a GSM system or a CDMA system, a home base station (e.g., home evolved node B, or home node B, HNB), a baseband unit (BBU), a transmitting and receiving point (TRP), a transmitting point (TP), a mobile switching center, or the like.

For a case where the system information (SI) window for any actually transmitted synchronization signal/PBCH block (SSB) includes at least one Physical Downlink Control Channel (PDCCH) monitoring occasion (MO), a user equipment needs to monitor all PDCCH MOs in the SI window in a case where the user equipment is uncertain about on which PDCCH MO in the SI window the network device transmits the downlink control information (DCI). This may result in wasted energy consumption of the user equipment.

A system information (SI) window is a periodic window. In a case where a synchronization signal/PBCH block (SSB) corresponds to a plurality of monitoring occasions (MOs) in each SI window, or in other words in a case where in an SI window a SSB corresponds to a plurality of MOs, the user equipment may be configured not to perform monitoring on all of the plurality of MOs in each SI window in order to save energy consumption of the user equipment. That is, the user equipment may perform monitoring only on partial MOs of the plurality of MOs in each SI window, and does not need to perform monitoring on MOs other than the partial MOs.

A selection mode may be defined, and this selection mode involves selecting the partial MOs of the plurality of MOs in each SI window. According to this selection mode, the network device determines which MOs of the plurality of MOs in each SI window are selected for transmitting the DCI configured for scheduling the SI. Further, according to this selection mode, the user equipment determines which MOs of the plurality of MOs in each SI window are selected for receiving the DCI configured for scheduling the SI. In this way, the energy consumption of the user equipment and the network device may be both saved.

Alternatively, in a case where it is defined that the network device transmits, on every MO in each SI window, the DCI configured for scheduling the SI, the user equipment may be configured to determine, according to this selection mode, which MOs of the plurality of MOs in each SI window are selected for receiving the DCI configured for scheduling the SI. In this way, the energy consumption of the user equipment is saved at the expense of the energy consumption of the network device.

Alternatively, in a case where it is not defined that on which MOs the network device transmits the DCI configured for scheduling the SI, the user equipment is configured to not monitor on a subsequent monitoring occasion the DCI configured for scheduling the SI, after the DCI configured for scheduling the SI is monitored in the same SI window. In this way, redundant monitoring after successful monitoring is avoided, and energy consumption of the user equipment is saved.

A method for monitoring downlink control information is provided by an embodiment of the present disclosure. The method is applicable to an application scenario where one synchronization signal/PBCH block (SSB) corresponds to a plurality of MOs in each system information (SI) window. In this method, the user equipment and the network device select the same partial MOs of the plurality of MOs corresponding to the SSB in one SI window, and use the partial MOs.

FIG. 2 is a flowchart of a method for transmitting and monitoring downlink control information according to an example. As shown in FIG. 2, the method includes steps S201 to S203.

In step S201, a network device and a user equipment determine a same partial MOs of the plurality of MOs corresponding to the SSB in the SI window.

In an embodiment, both the network device and the user equipment determine the partial MOs of the plurality of MOs corresponding to the SSB in one SI window according to a protocol convention.

In an example, position information of the partial MOs of the plurality of MOs is stipulated in the protocol. The network device and the user equipment may determine the same partial MOs based on the position information stipulated in the protocol.

In another example, a selection mode is stipulated in the protocol. The network device and the user equipment may select the same partial MOs of the plurality of MOs according to the selection mode stipulated in the protocol.

In another embodiment, the network device transmits indication information to the user equipment after determining the selection mode. The indication information is configured to indicate the partial monitoring occasions of the plurality of monitoring occasions corresponding to the SSB in the SI window.

In an example, the indication information indicates position information of the partial MOs among the plurality of MOs. The user equipment may determine the partial MOs based on the position information indicated by the indication information.

In another example, the indication information is configured to indicate a selection mode. The selection mode is configured to determine the partial monitoring occasions of the plurality of monitoring occasions corresponding to the SSB in the SI window. By receiving the indication information transmitted by the network device, the user equipment may select the partial MOs of the plurality of MOs according to the selection mode indicated by the indication information.

In step S202, the network device transmits, on the partial MOs, the DCI configured for scheduling the SI, and does not transmit, on MOs other than the partial MOs in the SI window, the DCI configured for scheduling the SI.

In step S203, the user equipment monitors, on the partial MOs, the DCI configured for scheduling the SI, and does not monitor, on MOs other than the partial MOs in the SI window, the DCI configured for scheduling the SI.

In an example, the partial monitoring occasions of the plurality of monitoring occasions corresponding to the SSB in the SI window include: a first monitoring occasion of the plurality of monitoring occasions corresponding to the SSB in the SI window.

In another example, the partial monitoring occasions of the plurality of monitoring occasions corresponding to the SSB in the SI window include: a last monitoring occasion of the plurality of monitoring occasions corresponding to the SSB in the SI window.

In an example, the partial monitoring occasions of the plurality of monitoring occasions corresponding to the SSB in the SI window include: a first to an N-th monitoring occasions of the plurality of monitoring occasions corresponding to the SSB in the SI window. N is a set value.

In another example, the partial monitoring occasions of the plurality of monitoring occasions corresponding to the SSB in the SI window include: an N-th to a last monitoring occasions of the plurality of monitoring occasions corresponding to the SSB in the SI window. N is a set value.

In an example, the partial monitoring occasions of the plurality of monitoring occasions corresponding to the SSB in the SI window include: a first to an M-th monitoring occasions of the plurality of monitoring occasions corresponding to the SSB in the SI window. M is a round-down value of X/2, i.e., floor (X/2), and X is a number of the monitoring occasions corresponding to the SSB in the SI window.

In another example, the partial monitoring occasions of the plurality of monitoring occasions corresponding to the SSB in the SI window include: an M-th to a last monitoring occasions of the plurality of monitoring occasions corresponding to the SSB in the SI window. M is a round-down value of X/2, i.e., floor (X/2), and X is a number of the monitoring occasions corresponding to the SSB in the SI window.

In other examples, a plurality of consecutive MOs in a middle portion of the plurality of monitoring occasions corresponding to the SSB in the SI window may also be determined according to a set rule. Alternatively, a plurality of non-consecutive MOs of the plurality of monitoring occasions corresponding to the SSB in the SI window may also be determined according to a different set rule. The wording “consecutive” and “non-consecutive” refer to a relationship between the plurality of monitoring occasions corresponding to the SSB in the SI window, without considering a time-domain region between two MOs.

A method for transmitting or monitoring downlink control information is provided by an embodiment of the present disclosure. The method is applicable to an application scenario where one synchronization signal/PBCH block (SSB) corresponds to a plurality of MOs in each SI window. In this method, the network device transmits the DCI on each of the plurality of MOs, and the user equipment monitors the DCI only on partial MOs of the plurality of MOs.

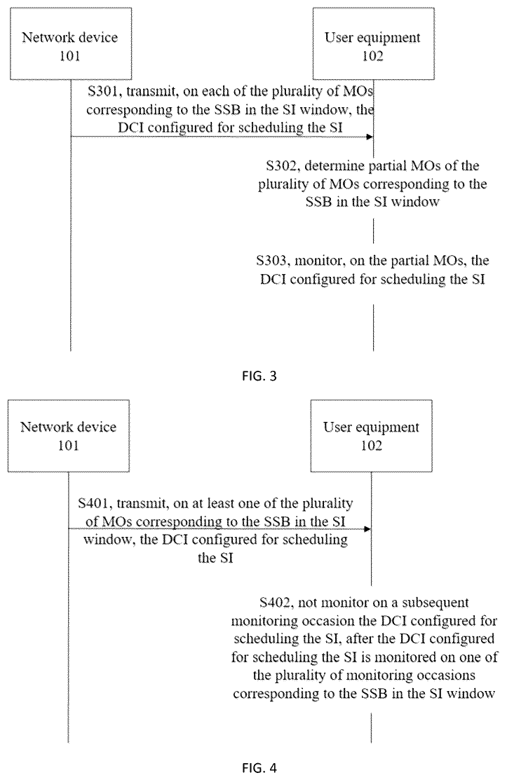

FIG. 3 is a flowchart of a method for transmitting and monitoring downlink control information according to an example. As shown in FIG. 3, the method includes steps S301 to S303.

In step S301, the network device transmits, on each of the plurality of MOs corresponding to the SSB in the SI window, the DCI configured for scheduling the SI.

In step S302, the user equipment determines partial MOs of the plurality of MOs corresponding to the SSB in the SI window.

In an example, the position information of the partial MOs of the plurality of MOs is stipulated in the protocol. The user equipment may determine the same partial MOs based on the position information stipulated in the protocol.

In another example, a selection mode is stipulated in the protocol. The user equipment may select the same partial MOs of the plurality of MOs according to the selection mode stipulated in the protocol.

In another example, the user equipment receives the indication information transmitted by the network device. The indication information is configured to indicate the partial monitoring occasions of the plurality of monitoring occasions corresponding to the SSB in the SI window.

In step S303, the user equipment monitors, on the partial MOs, the DCI configured for scheduling the SI, and does not transmit, on MOs other than the partial MOs in the SI window, the DCI configured for scheduling the SI.

A method for transmitting or monitoring downlink control information is provided by an embodiment of the present disclosure. The method is applicable to an application scenario where one synchronization signal/PBCH block (SSB) corresponds to a plurality of MOs in each system information (SI) window. In this method, the network device transmits the DCI on all or partial MOs of the plurality of MOs, and the user equipment monitors the DCI only on partial MOs of the plurality of MOs.

FIG. 4 is a flowchart of a method for transmitting and monitoring downlink control information according to an example, and this method is applicable scenarios where one synchronization signal/PBCH block (SSB) corresponds to a plurality of monitoring occasions in each system information (SI) window. As shown in FIG. 4, the method includes steps S401 to S402.

In step S401, the network device transmits, on at least one of the plurality of MOs corresponding to the SSB in the SI window, the DCI configured for scheduling the SI.

In step S402, the user equipment does not monitor on a subsequent monitoring occasion the DCI configured for scheduling the SI, after the DCI configured for scheduling the SI is monitored on one of the plurality of monitoring occasions corresponding to the SSB in the SI window.

In an example, the network device transmits, on each of the plurality of MOs corresponding to the SSB in the SI window, the DCI configured for scheduling the SI, and the user equipment does not monitor on a subsequent monitoring occasion the DCI configured for scheduling the SI, after the DCI configured for scheduling the SI is monitored on the first MO of the plurality of MOs.

Since each SI has its corresponding SI window, the plurality of monitoring occasions corresponding to the SSB in the SI window refer to a plurality of monitoring occasions corresponding to the SSB within the SI window corresponding to this SSB.

In an example, the SI and this SI's corresponding SI window are calculated as follows:
a starting slot of an SI window corresponding to SI n is as follows: α=x mod N;
an SFN where the SI window lies is as follows: SFN mod T=FLOOR (x/N)
where, α is an identity of the starting slot, n is the sequential index of this SI in one or more SIs included in SI scheduling information, N is a number of slots included in one radio frame, and T is a period of SI n·x=(n−1)×w, w is a length of the SI window. SFN is a system frame number.

A method for monitoring downlink control information is provided by an embodiment of the present disclosure. The method is performed by a user equipment. The method is applicable to an application scenario where the synchronization signal/PBCH block (SSB) corresponds to the plurality of monitoring occasions in each system information (SI) window.

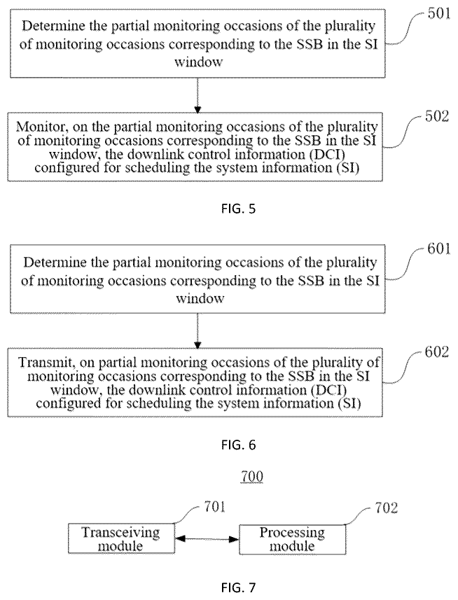

FIG. 5 is a flowchart of a method for monitoring downlink control information according to an example. As shown in FIG. 5, the method includes steps S501 to S502.

In step S501, the partial monitoring occasions of the plurality of monitoring occasions corresponding to the SSB in the SI window are determined.

In step S502, the downlink control information (DCI) configured for scheduling the system information (SI) is monitored on the partial monitoring occasions of the plurality of monitoring occasions corresponding to the SSB in the SI window.

In some embodiments, the plurality of monitoring occasions corresponding to the SSB in the SI window may also be described as a plurality of monitoring occasions corresponding to the SSB in the SI window.

In some embodiments, step S502 further includes: not monitoring, on monitoring occasions other than the partial monitoring occasions in the SI window, the downlink control information (DCI) configured for scheduling the system information (SI).

In some embodiments, determining the partial monitoring occasions of the plurality of monitoring occasions corresponding to the SSB in the SI window includes:
determining the partial monitoring occasions of the plurality of monitoring occasions corresponding to the SSB in the SI window according to a protocol convention.

In an example, the position information of the partial MOs of the plurality of MOs is stipulated in the protocol. The user equipment may determine the same partial MOs based on the position information stipulated in the protocol.

In another example, a selection mode is stipulated in the protocol. The user equipment may select the same partial MOs of the plurality of MOs according to the selection mode stipulated in the protocol.

In some embodiments, determining the partial monitoring occasions of the plurality of monitoring occasions corresponding to the SSB in the SI window includes:
receiving indication information transmitted by a network device, and determining partial monitoring occasions of the plurality of monitoring occasions corresponding to the SSB in the SI window based on the indication information.

In an example, the indication information indicates position information of partial MOs of the plurality of MOs. The user equipment may determine the partial MOs based on the position information indicated by the indication information.

In another example, the indication information is configured to indicate a selection mode. The selection mode is configured to determine partial monitoring occasions of the plurality of monitoring occasions corresponding to the SSB in the SI window. By receiving the indication information transmitted by the network device, the user equipment may select partial MOs of the plurality of MOs according to the selection mode indicated by the indication information.

In an example, the partial monitoring occasions of the plurality of monitoring occasions corresponding to the SSB in the SI window include: a first monitoring occasion of the plurality of monitoring occasions corresponding to the SSB in the SI window.

In another example, the partial monitoring occasions of the plurality of monitoring occasions corresponding to the SSB in the SI window include: a last monitoring occasion of the plurality of monitoring occasions corresponding to the SSB in the SI window.

In an example, the partial monitoring occasions of the plurality of monitoring occasions corresponding to the SSB in the SI window include: a first to an N-th monitoring occasions of the plurality of monitoring occasions corresponding to the SSB in the SI window. N is a set value.

In another example, the partial monitoring occasions of the plurality of monitoring occasions corresponding to the SSB in the SI window include: an N-th to a last monitoring occasions of the plurality of monitoring occasions corresponding to the SSB in the SI window. N is a set value.

In an example, the partial monitoring occasions of the plurality of monitoring occasions corresponding to the SSB in the SI window include: a first to an M-th monitoring occasions of the plurality of monitoring occasions corresponding to the SSB in the SI window. M is a round-down value of X/2, i.e., floor (X/2), and X is a number of the monitoring occasions corresponding to the SSB in the SI window.

In another example, the partial monitoring occasions of the plurality of monitoring occasions corresponding to the SSB in the SI window include: an M-th to a last monitoring occasions of the plurality of monitoring occasions corresponding to the SSB in the SI window. M is a round-down value of X/2, i.e., floor (X/2), and X is a number of the monitoring occasions corresponding to the SSB in the SI window.

In other examples, a plurality of consecutive MOs in a middle portion of the plurality of monitoring occasions corresponding to the SSB in the SI window may also be determined according to a set rule. Alternatively, a plurality of non-consecutive MOs of the plurality of monitoring occasions corresponding to the SSB in the SI window may also be determined according to a different set rule. The wording “consecutive” and “non-consecutive” refer to a relationship between the plurality of monitoring occasions corresponding to the SSB in the SI window, without considering a time-domain region between two MOs.

In some embodiments, monitoring, on partial monitoring occasions of the plurality of monitoring occasions corresponding to the SSB in the SI window, the DCI configured for scheduling the SI includes: not monitoring on a subsequent monitoring occasion the DCI configured for scheduling the SI, after the DCI configured for scheduling the SI is monitored on one of the plurality of monitoring occasions corresponding to the SSB in the SI window.

In an example, the network device transmits, on each of the plurality of MOs corresponding to the SSB in the SI window, the DCI configured for scheduling the SI, and the user equipment does not monitor on a subsequent monitoring occasion the DCI configured for scheduling the SI, after the DCI configured for scheduling the SI is monitored on the first MO of the plurality of MOs.

A method for transmitting downlink control information is provided by an embodiment of the present disclosure. The method is performed by a network device. The method is applicable to an application scenario where the synchronization signal/PBCH block (SSB) corresponds to the plurality of monitoring occasions in each system information (SI) window.

FIG. 6 is a flowchart of a method for transmitting downlink control information according to an example. As shown in FIG. 6, the method includes steps S601 to S602.

In step S601, the partial monitoring occasions of the plurality of monitoring occasions corresponding to the SSB in the SI window are determined.

In some embodiments, the partial monitoring occasions of the plurality of monitoring occasions corresponding to the SSB in the SI window are determined according to a protocol convention.

In some embodiments, the partial monitoring occasions of the plurality of monitoring occasions corresponding to the SSB in the SI window include: a first to an M-th monitoring occasions of the plurality of monitoring occasions corresponding to the SSB in the SI window, where M is a round-down value of X/2, and X is a number of the monitoring occasions corresponding to the SSB in the SI window.

In some embodiments, the partial monitoring occasions of the plurality of monitoring occasions corresponding to the SSB in the SI window include: a first monitoring occasion or a last monitoring occasion of the plurality of monitoring occasions corresponding to the SSB in the SI window.

In step S602, downlink control information (DCI) configured for scheduling the system information (SI) are transmitted on partial monitoring occasions of the plurality of monitoring occasions corresponding to the SSB in the SI window.

In some embodiments, step S602 further includes: not transmitting, on monitoring occasions other than partial monitoring occasions in the SI window, the downlink control information (DCI) configured for scheduling the system information (SI).

In some embodiments, between steps S601 and S602, the method further includes: transmitting indication information to a user equipment, where the indication information is configured to indicate partial monitoring occasions of the plurality of monitoring occasions corresponding to the SSB in the SI window.

In an example, the indication information indicates position information of partial monitoring occasions of the plurality of MOs, and the user equipment may determine partial MOs based on the position information indicated by the indication information.

In another example, the indication information is configured to indicate a selection mode for determining partial monitoring occasions of the plurality of monitoring occasions corresponding to the SSB in the SI window. By receiving the indication information transmitted by the network device, the user equipment may select partial monitoring occasions of the plurality of MOs according to the selection mode indicated by the indication information.

Based on the same concept as the method embodiment, an embodiment of the present disclosure further provides a communication device that can have the functions of the user equipment 102 in the method embodiment, and is configured to perform the steps performed by the user equipment 102 provided by the embodiment. The functions may be implemented by hardware, or may be implemented by software or by hardware executing corresponding software. The hardware or software includes one or more modules corresponding to the functions.

In an embodiment, the communication device 700 as shown in FIG. 7 may act as the user equipment 102 according to the method embodiment and perform the steps performed by the user equipment 102 in one of the method embodiments.

The communication device 700 includes a transceiving module 701 and a processing module 702.

The transceiving module 701 is configured to, monitor in a case where a synchronization signal/PBCH block (SSB) corresponds to a plurality of monitoring occasions in each system information (SI) window, on partial monitoring occasions of the plurality of monitoring occasions corresponding to the SSB in the SI window, DCI configured for scheduling SI.

In some embodiments, the processing module 702 is configured to determine the partial monitoring occasions of the plurality of monitoring occasions corresponding to the SSB in the SI window.

In some embodiments, the processing module 702 is further configured to determine the partial monitoring occasions of the plurality of monitoring occasions corresponding to the SSB in the SI window according to a protocol convention.

In some embodiments, the transceiving module 701 is further configured to receive indication information transmitted by the network device; and the processing module 702 is further configured to determine partial monitoring occasions of the plurality of monitoring occasions corresponding to the SSB in the SI window according to the indication information.

In some embodiments, the partial monitoring occasions of the plurality of monitoring occasions corresponding to the SSB in the SI window include: a first to an M-th monitoring occasions of the plurality of monitoring occasions corresponding to the SSB in the SI window, where M is a round-down value of X/2, and X is a number of the monitoring occasions corresponding to the SSB in the SI window.

In some embodiments, the partial monitoring occasions of the plurality of monitoring occasions corresponding to the SSB in the SI window include: a first monitoring occasion or a last monitoring occasion of the plurality of monitoring occasions corresponding to the SSB in the SI window.

In some embodiments, the transceiving module 701 is further configured to, not monitor on a subsequent monitoring occasion the DCI configured for scheduling the SI, after the DCI configured for scheduling the SI is monitored on one of the plurality of monitoring occasions corresponding to the SSB in the SI window.

In a case where the communication device is a user equipment 102, the communication device's structure may also be as shown in FIG. 8.

FIG. 8 is a block diagram illustrating a device 800 for monitoring downlink control information according to an example. For example, the device 800 may be a mobile phone, a computer, a digital broadcast terminal, a messaging device, a gaming console, a tablet device, a medical device, a fitness device, a personal digital assistant, or the like.

Referring to FIG. 8, the device 800 may include one or more of a processing component 802, a memory 804, a power component 806, a multimedia component 808, an audio component 810, an input/output (I/O) interface 812, a sensor component 814, and a communication component 816.

The processing component 802 generally controls overall operations of the device 800, such as operations associated with displays, phone calls, data communications, camera operations, and recording operations. The processing component 802 may include one or more processors 820 to execute instructions to perform all or a portion of the steps of the methods. Additionally, the processing component 802 may include one or more modules that facilitate interaction between the processing component 802 and other components. For example, the processing component 802 may include a multimedia module to facilitate interaction between the multimedia component 808 and the processing component 802.

The memory 804 is configured to store various types of data to support the operation of the device 800. Examples of such data include instructions for any application or method operating on the device 800, contact data, phonebook data, messages, pictures, video, etc. The memory 804 may be implemented by any type or combination of volatile or non-volatile storage devices, such as static random access memory (SRAM), electrically erasable programmable read-only memory (EEPROM), erasable programmable read-only memory (EPROM), programmable read-only memory (PROM), read-only memory (ROM), magnetic memory, Flash memory, magnetic or optical disk.

A power component 806 provides power for the various components of the device 800. The power component 806 can include a power management system, one or more power sources, and other components associated with generating, managing, and distributing power for the device 800.

The multimedia component 808 includes a screen that provides an output interface between the device 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense the boundary of a touch or swipe action, but also detect the duration and pressure associated with the touch or swipe operation. In some embodiments, the multimedia component 808 includes a front camera and/or a rear camera. When the device 800 is in an operating mode, such as a shooting mode or a video mode, the front camera and/or the rear camera may receive external multimedia data. Each front camera and rear camera may be a fixed optical lens system or have focal length and optical zoom capability.

The audio component 810 is configured to output and/or input audio signals. For example, the audio component 810 includes a microphone (MIC) configured to receive external audio signals when the device 800 is in an operating mode, such as a call mode, a recording mode, and a voice recognition mode. Received audio signals may be further stored in the memory 804 or transmitted via the communication component 816. In some embodiments, the audio component 810 further includes a speaker for outputting audio signals.

The I/O interface 812 provides an interface between the processing component 802 and peripheral interface modules, such as keyboards, click wheels, buttons, and the like. These buttons may include, but are not limited to, a home button, a volume button, a start button, and a lock button.

The sensor component 814 includes one or more sensors for providing status assessments of various aspects for the device 800. For example, the sensor component 814 may detect an open/closed state of the device 800, the relative positioning of the components, such as the display and keypad of the device 800, the sensor component 814 can also detect changes in the position of the device 800 or a component of the device 800, the presence or absence of user contact with the device 800, changes in the orientation or acceleration/deceleration of the device 800, and temperature of the device 800. The sensor component 814 may include a proximity sensor configured to detect the presence of a nearby object in the absence of any physical contact. The sensor component 814 may also include a light sensor, such as a CMOS or CCD image sensor, for use in imaging applications. In some embodiments, the sensor component 814 may also include an acceleration sensor, a gyro sensor, a magnetic sensor, a pressure sensor, or a temperature sensor.

The communication component 816 is configured to facilitate communication, wired or wirelessly, between the device 800 and other devices. The device 800 may access a wireless network based on a communication standard, such as WiFi, 4G, or 5G, or a combination of them. In an example, the communication component 816 receives a broadcast signal or broadcast related information from an external broadcast management system via a broadcast channel. In an example, the communication component 816 also includes a near field communication (NFC) module to facilitate short range communication. For example, the NFC module may be implemented based on Radio Frequency Identification (RFID) technology, Infrared Data Association (IrDA) technology, Ultra Wide Band (UWB) technology, Bluetooth (BT) technology, and other technologies.

In an example, the device 800 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors, or other electronic elements, for performing the methods.

In an example, a non-transitory computer readable storage medium including instructions is provided, e.g., the memory 804 including instructions, executable by the processor 820 of the device 800 to perform the method. For example, the non-transitory computer readable storage medium may be a ROM, a random access memory (RAM), a CD-ROM, a magnetic tape, a floppy disk, an optical data storage device, and the like.

Based on the same concept as the method embodiment, an embodiment of the present disclosure further provides a communication device that can have the functions of the network device 101 in the method embodiment and is configured to perform the steps performed by the network device 101 provided by the embodiment. The functions may be implemented by hardware, or may be implemented by software or by hardware executing corresponding software. The hardware or software includes one or more modules corresponding to the functions.

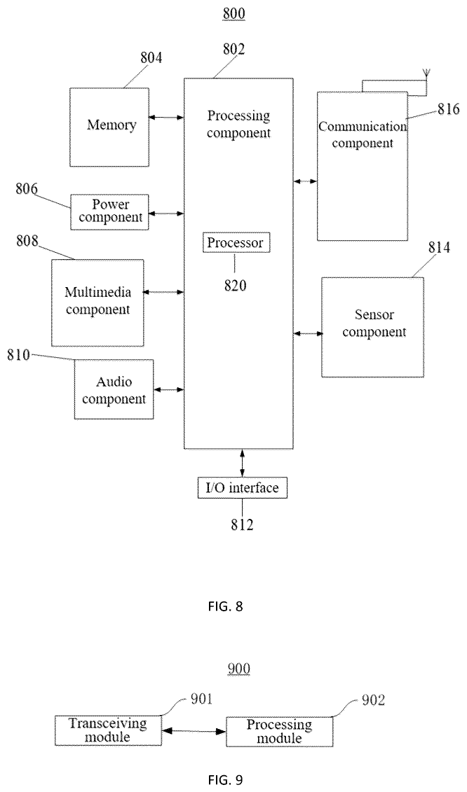

In an embodiment, the communication device 900 as shown in FIG. 9 may act as the network device 101 to which the method embodiments relate, and perform the steps performed by the network device 101 in the method embodiments.

The communication device 900 as shown in FIG. 9 includes a transceiving module 901 and a processing module 902 for performing the steps performed by the network device 101 in the method embodiments.

The transceiving module 901 is configured to, transmit in a case where a synchronization signal/PBCH block (SSB) corresponds to a plurality of monitoring occasions in each system information (SI) window, on partial monitoring occasions of the plurality of monitoring occasions corresponding to the SSB in the SI window, DCI configured for scheduling SI.

In some embodiments, the processing module 902 is configured to determine partial monitoring occasions of the plurality of monitoring occasions corresponding to the SSB in the SI window.

In some embodiments, the processing module 902 is further configured to determine partial monitoring occasions of the plurality of monitoring occasions corresponding to the SSB in the SI window according to a protocol convention.

In some embodiments, the transceiving module 901 is configured to transmit indication information to a user equipment, and the indication information is configured to indicate partial monitoring occasions of the plurality of monitoring occasions corresponding to the SSB in the SI window.

In some embodiments, the partial monitoring occasions of the plurality of monitoring occasions corresponding to the SSB in the SI window include: a first to an M-th monitoring occasions of the plurality of monitoring occasions corresponding to the SSB in the SI window, where M is a round-down value of X/2, and X is a number of the monitoring occasions corresponding to the SSB in the SI window.

In some embodiments, the partial monitoring occasions of the plurality of monitoring occasions corresponding to the SSB in the SI window include: a first monitoring occasion or a last monitoring occasion of the plurality of monitoring occasions corresponding to the SSB in the SI window.

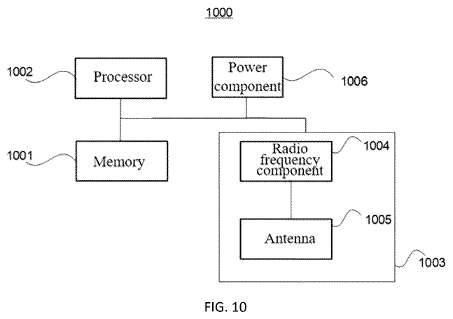

When the communication device is a network device 101, the communication device's structure may also be as shown in FIG. 10. As shown in FIG. 10, the device 1000 includes a memory 1001, a processor 1002, a transceiving component 1003, and a power component 1006. The memory 1001 is coupled to the processor 1002 and can be used to store programs and data necessary to implement various functions of the communication device 1000. The processor 1002 is configured to support the communication device 1000 to perform the corresponding functions of the method, and the functions may be implemented by invoking the programs stored in the memory 1001. The transceiving component 1003 may be a wireless transceiver that may be configured to support the communication device 1000 for receiving signaling and/or data and transmitting signaling and/or data over a wireless air interface. The transceiving component 1003 may also be referred to as a transceiving unit or a communication unit, the transceiving component 1003 may include a radio frequency component 1004, which may be a remote radio unit (RRU), particularly for transmission of radio frequency signals and conversion of radio frequency signals to baseband signals, and one or more antennas 1005, particularly for radiation and reception of radio frequency signals.

When the communication device 1000 needs to transmit data, the processor 1002 performs baseband processing on the data to be transmitted and outputs a baseband signal to the radio frequency unit, and the radio frequency unit performs radio frequency processing on the baseband signal and transmits the radio frequency signal in the form of an electromagnetic wave through an antenna. When data is transmitted to the communication device 1000, the radio frequency unit receives a radio frequency signal through an antenna, converts the radio frequency signal into a baseband signal, and outputs the baseband signal to the processor 1002, which converts the baseband signal into data and processes the data.

In the present disclosure, in a case where a synchronization signal/PBCH block (SSB) corresponds to a plurality of monitoring occasions in each system information (SI) window, the user equipment monitors, on partial monitoring occasions of the plurality of monitoring occasions corresponding to the SSB in the SI window, the DCI configured for scheduling the SI. The energy consumption of the user equipment may be saved, compared with a way of monitoring the DCI configured for scheduling the SI on all of the plurality of monitoring occasions corresponding to the SSB in the SI window.

Other implementations of the disclosed embodiments will be apparent to those skilled in the art from consideration of the specification and practice of the present disclosure disclosed. The present application is intended to cover any modifications, uses, or adaptations of the embodiments of the present disclosure, which follow the general principles of the embodiments of the present disclosure and include common knowledge or conventional technical means in the technical field not disclosed in the present disclosure. The specification and examples are to be regarded as exemplary only, and the true scope and spirit of the embodiments of the present disclosure are indicated by the following claims.

It is to be understood that the embodiments of the present disclosure are not limited to the precise structures and illustrated in the accompanying drawings, and various modifications and changes can be made without departing from the scope of the present disclosure. The scope of embodiments of the present disclosure is limited only by the appended claims.

### Industrial Applicability

The user equipment monitors, on partial monitoring occasions of the plurality of monitoring occasions corresponding to the SSB in the SI window, the DCI configured for scheduling the SI. The energy consumption of the user equipment may be saved.

1. A method for monitoring downlink control information (DCI), performed by a user equipment, the method comprising:
monitoring in a case where a synchronization signal/PBCH block (SSB) corresponds to a plurality of monitoring occasions in each system information (SI) window, on partial monitoring occasions of the plurality of monitoring occasions corresponding to the SSB in the SI window, DCI configured for scheduling SI.

2. The method for monitoring DCI according to claim 1, wherein the method further comprises determining the partial monitoring occasions of the plurality of monitoring occasions corresponding to the SSB in the SI window.

3. The method for monitoring DCI according to claim 2, wherein determining the partial monitoring occasions of the plurality of monitoring occasions corresponding to the SSB in the SI window comprises:
determining the partial monitoring occasions of the plurality of monitoring occasions corresponding to the SSB in the SI window according to a protocol convention.

4. The method for monitoring DCI according to claim 2, wherein determining the partial monitoring occasions of the plurality of monitoring occasions corresponding to the SSB in the SI window comprises:
receiving indication information transmitted by a network device, and determining the partial monitoring occasions of the plurality of monitoring occasions corresponding to the SSB in the SI window based on the indication information.

5. The method for monitoring DCL according to claim 2, wherein
the partial monitoring occasions of the plurality of monitoring occasions corresponding to the SSB in the SI window comprise a first to an M-th monitoring occasions of the plurality of monitoring occasions corresponding to the SSB in the SI window, wherein M is a round-down value of X/2, and X is a number of the monitoring occasions corresponding to the SSB in the SI window.

6. The method for monitoring DCI according to claim 2, wherein
the partial monitoring occasions of the plurality of monitoring occasions corresponding to the SSB in the SI window comprise a first monitoring occasion or a last monitoring occasion of the plurality of monitoring occasions corresponding to the SSB in the SI window.

7. The method for monitoring DCI according to claim 1, wherein monitoring, on the partial monitoring occasions of the plurality of monitoring occasions corresponding to the SSB in the SI window, the DCI configured for scheduling the SI comprises:
not monitoring on a subsequent monitoring occasion the DCI configured for scheduling the SI, after the DCI configured for scheduling the SI is monitored on one of the plurality of monitoring occasions corresponding to the SSB in the SI window.

8. A method for transmitting downlink control information (DCI), performed by a network device, the method comprising:
transmitting in a case where a synchronization signal/PBCH block (SSB) corresponds to a plurality of monitoring occasions in each system information (SI) window, on partial monitoring occasions of the plurality of monitoring occasions corresponding to the SSB in the SI window, DCI configured for scheduling SI.

9. The method for transmitting DCI according to claim 8, wherein the method further comprises determining the partial monitoring occasions of the plurality of monitoring occasions corresponding to the SSB in the SI window.

10. The method for transmitting DCI according to claim 9, wherein determining the partial monitoring occasions of the plurality of monitoring occasions corresponding to the SSB in the SI window comprises:
determining the partial monitoring occasions of the plurality of monitoring occasions corresponding to the SSB in the SI window according to a protocol convention.

11. The method for transmitting DCI according to claim 9, wherein the method further comprises:
transmitting indication information to a user equipment, wherein the indication information is configured to indicate partial monitoring occasions of the plurality of monitoring occasions corresponding to the SSB in the SI window.

12. The method for transmitting DCI according to claim 9, wherein
the partial monitoring occasions of the plurality of monitoring occasions corresponding to the SSB in the SI window comprise a first to an M-th monitoring occasions of the plurality of monitoring occasions corresponding to the SSB in the SI window, wherein M is a round-down value of X/2, and X is a number of the monitoring occasions corresponding to the SSB in the SI window.

13. The method for transmitting DCI according to claim 9, wherein
the partial monitoring occasions of the plurality of monitoring occasions corresponding to the SSB in the SI window comprise a first monitoring occasion or a last monitoring occasion of the plurality of monitoring occasions corresponding to the SSB in the SI window.

14-15. (canceled)

16. An electronic device comprising one or more processors and a memory, wherein
the memory is configured to store a computer program, and
the one or more processors are collectively configured to perform the computer program to cause the electronic device to:
monitor in a case where a synchronization signal/PBCH block (SSB) corresponds to a plurality of monitoring occasions in each system information (SI) window, on partial monitoring occasions of the plurality of monitoring occasions corresponding to the SSB in the SI window, downlink control information (DCI) configured for scheduling SI.

17. An electronic device comprising one or more processors and a memory, wherein
the memory is configured to store a computer program, and
the one or more processors are collectively configured to perform the computer program to implement the method according to claim 8.

18. A non-transitory computer readable storage medium storing instructions, wherein the instructions, when executed on a computer, cause the computer to perform the method according to claim 1.

19. A non-transitory computer readable storage medium storing instructions, wherein the instructions, when executed on a computer, cause the computer to perform the method according to claim 8.

20. The electronic device according to claim 16, wherein the one or more processors are further configured to:
determine the partial monitoring occasions of the plurality of monitoring occasions corresponding to the SSB in the SI window.

21. The electronic device according to claim 20, wherein the one or more processors are further configured to:
determine the partial monitoring occasions of the plurality of monitoring occasions corresponding to the SSB in the SI window according to a protocol convention.

22. The electronic device according to claim 20, wherein the one or more processors are further configured to:
receive indication information transmitted by a network device, and determine the partial monitoring occasions of the plurality of monitoring occasions corresponding to the SSB in the SI window based on the indication information.
